(19) United States
(12) Patent Application Publication
(10) Pub. No.: US 2011/0295650 A1
(43) Pub. Date: Dec. 1, 2011

(54) Analyzing merchandise information for messiness

(75) Inventors: Feng Lin, Hangzhou (CN); Shousong Zhang, Hangzhou (CN); Qin Zhang, Hangzhou (CN)

(73) Assignee: Alibaba Group Holding Limited

(21) Appl. No.: 13/068,976

(22) Filed: May 24, 2011

(30) Foreign Application Priority Data
May 27, 2010 (CN) 201010187445.7

(51) Int. Cl. G06Q 10/00

(52) U.S. Cl. 705/7.32

(57) ABSTRACT

Analyzing merchandise information includes: receiving merchandise information input by a user; analyzing the merchandise information, including at least obtaining values corresponding to one or more characteristic attributes from the merchandise information, wherein the values corresponding to one or more characteristic attributes are used to determine whether the merchandise information is messy; determining a messiness confidence level associated with the merchandise information based at least in part on the obtained values corresponding to one or more characteristic attributes; and determining whether the messiness confidence level associated with the merchandise information exceeds a preset threshold value; in the event that the messiness confidence level exceeds the preset threshold value, sending an indication to stop publication of the merchandise information and in the event that the messiness confidence level does not exceed the preset threshold value, not sending an indication to stop publication of the merchandise information.

### CROSS REFERENCE TO OTHER APPLICATIONS

This application claims priority to People's Republic of China Patent Application No. 201010187445.7 entitled A METHOD AND DEVICE FOR PUBLISHING MERCHANDISE INFORMATION filed May 27, 2010 which is incorporated herein by reference for all purposes.

### FIELD OF THE INVENTION

The present application relates to online website technology. In particular, it relates to publishing merchandise information.

### BACKGROUND OF THE INVENTION

In the field of electronic commerce, the descriptive information (e.g., merchandise title) for a piece of merchandise contains important information on that product. For example, as can be seen in the example of FIG. 1, the title of the displayed merchandise is “&New arrived & Fashion wind coat, ladies' coat, fashion coat, women's wind coat (Wholesale price+Do dropship).” In this example, the merchandise title can accurately present the merchandise to the user as a women's windcoat. However, this merchandise title contains redundant information and is “messy” in its use of words. For example, the words “Fashion wind coat,” “fashion coat,” “ladies' coat” and “women's wind coat” overlap, at least partially, in meaning. These overlaps of meaning and redundancy of word use can diminish the conciseness and even accuracy of merchandise information at a website. Furthermore, displaying redundant and/or messy merchandise information, for example, for a user in response to a search at the website for merchandise information by the user can reduce the efficiency of the searching process.

### BRIEF DESCRIPTION OF THE DRAWINGS

Various embodiments of the invention are disclosed in the following detailed description and the accompanying drawings.

FIG. 1 is an example of merchandise information display at a webpage.

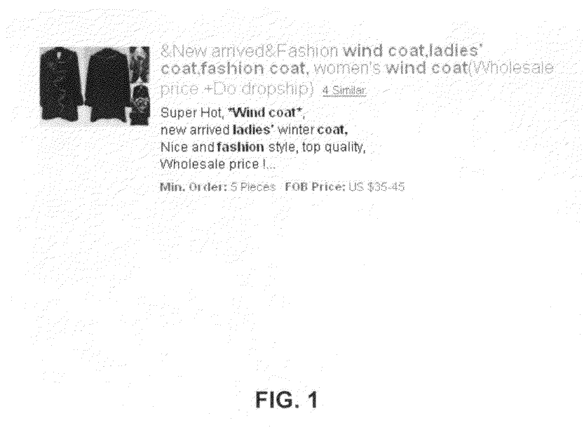

FIG. 2 is a diagram showing an embodiment of a system for analyzing merchandise information.

FIG. 3 is a diagram showing an embodiment of the merchandise information analysis server.

FIG. 4 is a diagram showing an embodiment of a messiness classifier.

FIG. 5 is a flow diagram showing an embodiment of a process for analyzing merchandise information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Analyzing merchandise information is disclosed. In some embodiments, merchandise information input by a user is received. In some embodiments, values corresponding to one or more characteristic attributes are obtained from the merchandise information, wherein the values corresponding to one or more characteristic attributes are used to determine whether the merchandise information is messy. In some embodiments, a messiness confidence level associated with the merchandise information is determined based at least in part on a maximum entropy principle for the obtained values corresponding to one or more characteristic attributes. In some embodiments, the maximum entropy principle is a formula that determines the messiness confidence level based on functions of values of the characteristic attributes associated with the input merchandise information. In some embodiments, it is determined whether the messiness confidence level exceeds a preset threshold value. In the event that the preset threshold value is exceeded, an indication to stop publication of the merchandise information is sent. In the event that the preset threshold value is not exceeded, an indication to stop publication of the merchandise information is not sent. In some embodiments, when the confidence level exceeds the preset threshold value, the merchandise information is deemed to be messy and an event is triggered in response (e.g., sending an indication to stop publication of the merchandise information).

In some embodiments, the concept of “messiness” can be described by the concepts of “enumeration” of the same product and “piling on” of different products. As used herein, “enumeration” of the same product refers to the concept that in a piece of merchandise information for a particular product, there are words that are redundant of each other or express substantially similar meanings. An example of “enumeration” of the same product is in a merchandise title for a particular product, many terms or phrases are synonyms or each other or that a certain keyword occurs several times within the title (e.g., a merchandise title that includes “coat,” “jacket,” “outerwear,” “red,” and “coat” again). As used herein, “piling on” of different products refers to the concept that within a piece of merchandise information, merchandise names of multiple, different products are included. An example of “piling on” of different products is a merchandise title that includes various keywords referring to different products (e.g., a merchandise title that includes the keywords: “mp3 player,” “mp4 player,” “ipod,” and “walkman”). As used herein, the degree of “messiness” is the degree to which merchandise information is “enumerated” and/or “piled on.” In various embodiments, merchandise information that is messy is not desirable to be published at a website such as an electronic commerce website (e.g., because it could contain unnecessary information that could mislead viewers).

In some embodiments, besides merchandise title, the merchandise information can include one or more other contents, for example: merchandise descriptive information, merchandise introductory information, merchandise reviews, merchandise product specifications. Merchandise information is not limited to only those listed.

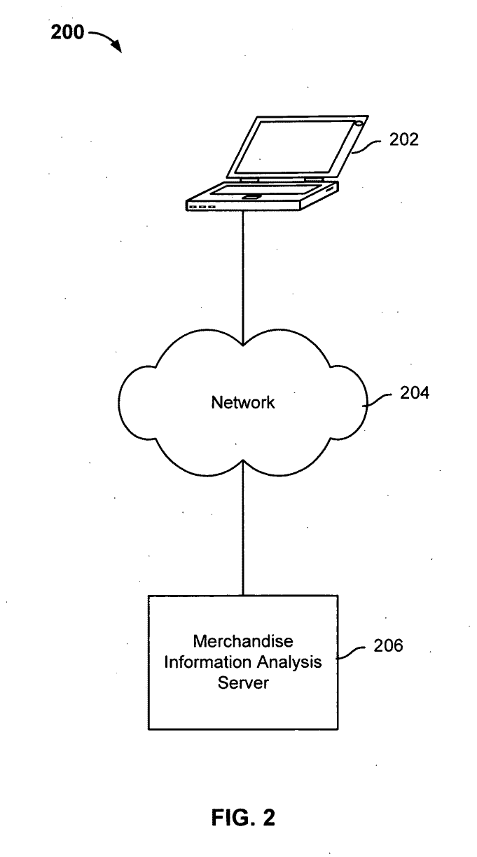

FIG. 2 is a diagram showing an embodiment of a system for analyzing merchandise information. System 200 includes device 202, network 204, and merchandise information analysis server 206. Network 204 includes various high speed data networks and/or telecommunication networks. In some embodiments, device 202 communicates with merchandise information analysis server 206 via network 204.

While device 202 is shown to be a laptop, examples of device 202 include a desktop computer, smart phone, mobile device, or a tablet device. Device 202 is capable of running a web browser (e.g., Microsoft Internet Explorer or Google Chrome). For example, a user can use device 202 to access an electronic commerce website (e.g., www.alibaba.com) via the web browser. The website can include interactive interfaces such that a user who wishes to advertise products on the website can submit information via the web interface.

Merchandise information analysis server 206 receives user submitted information (e.g., merchandise information) and determines whether the information is messy. In some embodiments, merchandise information analysis server 206 determines a confidence level associated with the merchandise information. In some embodiments, if the confidence level reaches or exceeds a preset threshold value, then the merchandise information is deemed to be messy. But if the confidence level does not reach or exceed the preset threshold value, then the merchandise information is deemed to be not messy. In some embodiments, if the merchandise information is deemed to be messy, then information analysis server 206 stops publication of the merchandise information (e.g., at an associated webpage) and/or displays a related indication to the user. In some embodiments, in the event that the merchandise information is determined to be messy, website information analysis server 206 prompts the user for a revision to the merchandise information.

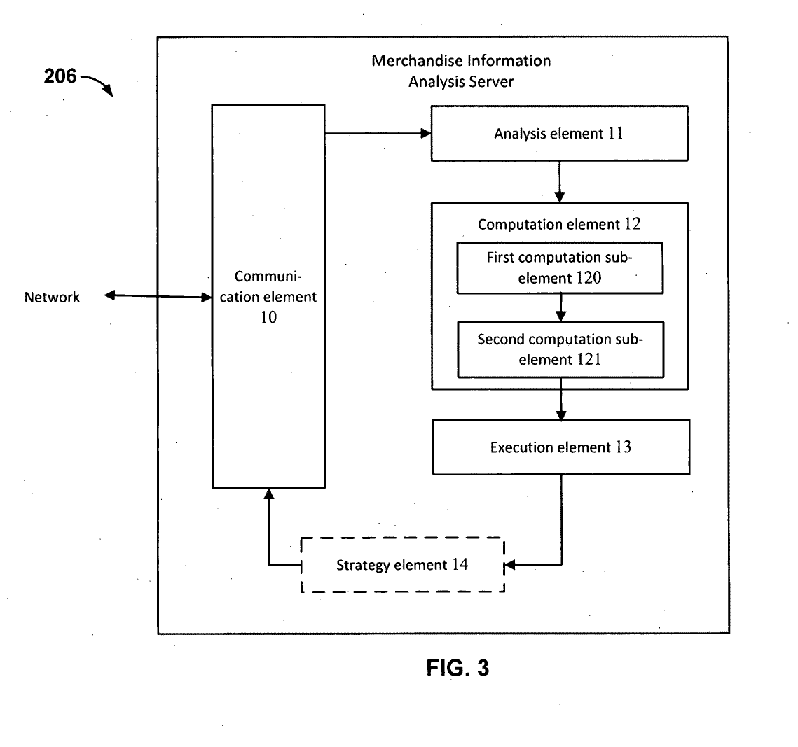

FIG. 3 is a diagram showing an embodiment of the merchandise information analysis server. In some embodiments, merchandise information analysis server 206 of FIG. 2 can be implemented, at least in part, using the example of FIG. 3. As shown in FIG. 3, merchandise information analysis server 206 includes communication element 10, analysis element 11, first analysis element 12, and second analysis element 13. In various embodiments, merchandise information analysis server 206 is implemented in association of (e.g., as combined with, as a component of, or in communication with) a server that supports a website (e.g., an electronic commerce website).

The elements described above can be implemented as software components executing on one or more general purpose processors, as hardware such as programmable logic devices and/or Application Specific Integrated Circuits designed to perform certain functions or a combination thereof. In some embodiments, the elements can be embodied by a form of software products which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The elements may be implemented on a single device or distributed across multiple devices. The functions of the elements may be merged into one another or further split into multiple sub-elements.

Communication element 10 receives merchandise information input by the user. In some embodiments, communication element 10 supports an interactive interface (e.g., at a webpage of the electronic commerce website) through which a user can view information and/or interact.

Analysis element 11 analyzes the merchandise information and obtains characteristic attribute values for the merchandise information. In some embodiments, characteristic attributes are used to determine the messiness of the words contained in the merchandise information.

Computation element 12 calculates the confidence level that the merchandise information is messy information based on the values of the characteristic attributes and the maximum entropy principle. The messiness confidence level refers to how likely the merchandise information is messy information.

In some embodiments and as shown in the example of FIG. 3, computation element 12 can further include first computation sub-element 120 and second computation sub-element 121.

First computation sub-element 120 is used to take the values of the characteristic attributes as input information for a conditional probability model based on the maximum entropy principle.

Second computation sub-element 121 is configured to use the conditional probability model to calculate, using the input information, the posterior probability that the merchandise information is messy information and to take the posterior probability as the confidence level that the merchandise information is messy information. In some embodiments, posterior probability of a random event can be described as the conditional probability that is assigned to the random event after the relevant evidence is taken into account.

Execution element 13 is configured to stop the publication of the merchandise information when it is determined that the confidence level has reached or exceeded a preset threshold value.

In some embodiments, strategy element 14 is optionally included in merchandise information analysis server 206. Strategy element 14 determines, in the event that the merchandise information is determined to be messy (e.g., the associated confidence level has reached or exceeded the preset threshold value) at least one keyword that appears to be causing the messiness of the words contained in the merchandise information. In some embodiments, one such keyword is the word that appears the most frequently among the merchandise information. In some embodiments, strategy element 14 sends the identified keyword to the user via communication element 10 and prompts the user to revise the originally submitted merchandise information. In some embodiments, strategy element 14 also includes optional revision options for the merchandise information.

In some embodiments, merchandise information analysis server 206 is configured to adopt a messiness-identification method based on machine learning. Merchandise information analysis server 206 uses the messiness-identification method to test the merchandise information that a user submits for publication (e.g., to a webpage associated with the offering of a product at an electronic commerce website). If the user-submitted merchandise information for publication is deemed to contain messiness (e.g., when it is determined the confidence level for the messiness of words contained in the merchandise information reaches or exceeds a preset threshold value), the publication of the merchandise information is stopped. In some embodiments, when the publication of the merchandise information is stopped, an indication of this event is sent to the user (e.g., via a display supported by communication element 10).

In some embodiments, the confidence level is calculated using a conditional probability model based on the maximum entropy principle. An example of a formula to be used to calculate the confidence level of one or more words of a user submitted merchandise information is as follows:

$$p ( y \vert x ) = \frac{1}{Z ( x )} exp ( {\sum }_{j} {λ}_{j} {f}_{j} ( x , y ) ) \qquad Formula 1$$

where yε{title is messy, title is not messy} indicates that y has two possible values, “title is messy” and “title is not messy.” The decision regarding which value (“title is messy” or “title is not messy”) to assign to y is based on preset parameters. For example, when the value of y is “title is messy,” the calculated p(y|x) is the posterior probability (i.e., confidence level) that the title contains messy information; and x is the characteristic attribute of the merchandise information. In some embodiments, the value of y associated with each characteristic attribute follows the value of that characteristic attribute. fⱼ is the characteristic value of each characteristic attribute based on the maximum entropy model. λⱼ is the weight corresponding to characteristic attribute j of the current merchandise information. In some embodiments, λⱼ can be preset (e.g., based on an empirical value). Z(x) is the normalizing factor that can also be preset (e.g., based on an empirical value).

In some embodiments, the machine-learning model used by the merchandise information analysis can be a linear regression model to establish the conditional probability model. In some embodiments, the machine-learning model used by the merchandise information analysis can be a support vector machine model, which although it is not a conditional probability model, its calculated fractions can be used as confidence levels.

In some embodiments, by using a formula such as Formula (1) as shown above, a messiness of merchandise information classifier is constructed. The input of the messiness of merchandise information classifier includes merchandise information and the output of the classifier includes the classification result. In some embodiments, the output of a classification result is a confidence level value and if the confidence level value is above a preset threshold, then it is determined that the input merchandise information is deemed to be messy but if the confidence level is below the preset threshold, then it is determined that the input merchandise information is not messy.

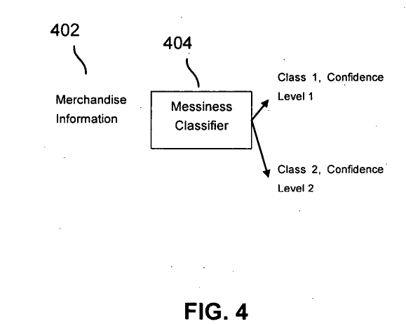

FIG. 4 is a diagram showing an embodiment of a messiness classifier. As shown in the example of FIG. 4, merchandise information 402 is input to messiness classifier 404, which outputs one of two possible classification results: Class 1, Confidence Level 1 or Class 2, Confidence Level 2. In some embodiments, the classification result of “title is messy” can be referred to as Class 1 and is the classification result of “title is not messy” can be referred as Class 2, as shown in the output area of FIG. 4.

In some embodiments, when a machine learning-based messiness-identification method is employed, the characteristic attributes obtained from the merchandise information are divided into morphological characteristic attributes and/or syntactical characteristic attributes. These two classes of characteristic attributes (morphological or syntactical) are explained below for the merchandise title example of analyzed merchandise information. Although in the following example, the merchandise information (e.g., the merchandise title) is analyzed for morphological characteristic attributes first and syntactical characteristic attributes second, in some embodiments, the merchandise information may be analyzed for syntactical characteristic attributes before or concurrently with morphological characteristic attributes.

First, the morphological characteristic attributes are obtained from the merchandise title. Examples of values corresponding to morphological characteristic attributes can include, but is not limited to, one or more of the following:

1. The number of commas contained in the merchandise title.

The number of commas contained in the merchandise title is consider to potentially reflect, to a certain extent, the probability that the words contained in the merchandise title are messy (and as a consequence, the merchandise title is messy). Generally, the more commas there are in a merchandise title, the greater the probability that the words contained in the merchandise title are messy.

For example, in the merchandise title of “#24 Baseball Jersey, Baseball Jerseys, Jerseys, Sports Jerseys, Sport Jersey, Jersey, 24# Baseball Jersey,” there are 6 commas.

2. The sentence length of the merchandise title (e.g., the number of words+the number of commas).

Generally, because a messy merchandise title contains more redundant information, the longer the sentence length of a merchandise title, the higher the probability that the words of the merchandise title are messy.

For example, the merchandise title “100% Original Asus P6T7 WS SuperComputer Motherboard, ASUS Motherboard, Computer Motherboard, Computer Mainboard, Motherboard” has a sentence length of 18.

3. The ratio of the number of words contained in the merchandise title after the removal of repetitive words to the total number of words in the merchandise title.

Generally, for merchandise titles that have undergone stemming, the smaller the ratio of the number of words after removal of repetitive words to the total number of words in the merchandise title, the greater the likelihood that the title is messy. What is meant by “stemming” is the removal of suffixes from English words and the retention of the stem. An example of a stemming is the removal of all suffixes that pertain to plurality (e.g., removing “s” from “laptops”). However, when the merchandise titles are in Chinese, the “stemming” step is omitted.

For example, after the merchandise title “100% Original Asus P6T7 WS SuperComputer Motherboard, ASUS Motherboard, Computer Motherboard, Computer Mainboard, Motherboard” has undergone stemming involving removing the suffix “er,” the corresponding word string becomes “100% Origin Asus P6T7 WS SuperComput Motherboard ASUS Motherboard Comput Motherboard Comput Mainboard Motherboard” (14 words). After the repetitive words are removed, the sentence becomes “100% Origin Asus P6T7 WS SuperComput Motherboard Comput Mainboard” (9 words). Thus, in this example, the ratio of the number of words in the merchandise title after the removal of repetitive words to the total number of words is 9/14.

4. The number of occurrences of the most frequently occurring word in the merchandise title.

Generally, the more frequently a word appears in the merchandise title, the greater the probability that the merchandise title will be messy. In some embodiments, the most frequently occurring word is deemed to be the word that is mainly causing the messiness of the merchandise information.

For example, after the merchandise title “09 branded handbag, designer handbag, new style handbag, fashion handbag, ladies' handbag, elegant handbag” has undergone stemming, the word that occurs most frequently is the word “handbag,” which occurs 6 times. In this example, this merchandise title is determined to be messy with respect to the word “handbag.”

5. The ratio of the number of words following the removal of repetitive words to the total number of words in a set, which is composed of the words in a specified position within each segment after the merchandise title has been divided based on preset rules into segments (a segment refers to a subset of all the words/phrases of the original merchandise title).

Generally, the aforementioned preset rules include but are not limited to: divide the merchandise title into segments based on the positions of the commas in the merchandise title and/or divide the merchandise title into segments based on the positions of the word that occurs most frequently in the merchandise title. The two methods described above are merely examples and do not exclude other methods of segmenting the merchandise title.

a) Using an example of comma-based division as a form of segmenting, after the merchandise title is divided into segments based on the positions of the commas contained in the title, the final word/phrase (e.g., the word/phrase just before a point in the merchandise title in which a division occurred) in each segment is designated as a member of a set. In such a set, the lower the ratio of the number of words after the removal of repetitive words from the set to the total number of words in the set (including the repetitive words), the greater the probability that the words contained in the merchandise title are messy.

For example, for the merchandise title “Paypal-Fashion sunglasses, ED sunglasses□CA sunglasses, Brand name sunglasses, designer sunglasses,” after the words have undergone stemming and the title has been split up based on the commas, the resulting set of segments is {“Paypal-Fashion sunglass”, “ED sunglass”, “CA sunglass”, “Brand nam sunglass”, “design sunglass”}, and the set of the final words from each segment is {“sunglass”, “sunglass”, “sunglass”, “sunglass”, “sunglass”}. After removal of the repetitive words, the only word left in the set is {“sunglass”}. Thus, in the set of words composed of the last word in each segment, the ratio of the number of words after removal of the repetitive words to the total number of words in the set is 1/5.

b) Using another example of comma-based division as a form of segmenting, after the merchandise title is divided based on the positions of the commas contained in the title into a certain number of segments, the last two words/phrases (e.g., the last two words/phrases just before a point in the merchandise title in which a division occurred) of each segment are designated as members of a set. The lower the ratio of the number of bigrams (words composed of the last two words in each segment) following the removal of repetitive words to the total number of bigrams in the set (including the repetitive words), the higher the probability that the words contained in the merchandise title are messy.

For example, after the merchandise title “Degree name card holder, business card holder, name card case, business card case, card holder credit card holder” has undergone stemming and comma-based division, the resulting segment set is {“Degree nam card hold”, “busi card hold”, “nam card cas”, “busi card cas”, “card hold”, “credit card hold”}. The set composed of the last two words/phrases from each segment is {“card hold”, “card hold”, “card cas”, “card cas”, “card hold”, “card hold”}. The set after the removal of repetitive words is {“card hold”, “card cas”}. Thus, the ratio of bigrams after removal of repetitive words to total bigrams in the set is 1/3.

c) Using an example of dividing merchandise title into segments based on the highest-frequency word, after the merchandise title is divided into segments based on the most frequently occurring word contained in the title, the last word/phrase in each segment is designated a member of a set. Generally, the lower the ratio of the number of words following the removal of repetitive words to the total number of words in the set (including the repetitive words), the greater the probability that the words contained in the title are messy.

For example, a merchandise title is “New style Brand tshirt Polo tshirt Fashion tshirt mens Top quality tshirt Paypal.” After the merchandise title has gone under stemming, the merchandise title becomes “New styl Brand tshirt Polo tshirt Fashion tshirt men Top qualiti tshirt Payp,” and the word that occurs most frequently is “tshirt.” The sentence is divided using “tshirt” as the partition symbol. Thus, the resulting segment set is {“New styl Brand tshirt”, “Polo tshirt”, “Fashion tshirt”, “men Top qualiti tshirt”, “Payp”}. The set in which the last word in each segment is designated a member is {“tshirt”, “tshirt”, “tshirt”, “tshirt”, “Payp”}. The set after removal of repetitive words includes only {“Payp”}. Thus, in the set composed of the last word in each segment, the ratio of the number of words after the removal of repetitive words to the total number of words (including the repetitive words) in the set is 1/5.

In some embodiments, one or more of the segment-division methods introduced in a), b) and c) above and their corresponding ratio calculation methods are used. One can also implement a combination of segment-division methods a), b) and c) in order to increase the accuracy of calculation results.

6. After the merchandise title is divided based on preset rules into segments, the variance of each segment.

Using another example of comma-based division, after the merchandise title is divided based on the positions of the commas into segments, each segment is associated with its segment length, i.e. the number of words it contains. Generally, for a set of these segments derived from a merchandise title, the smaller the variance of segment length among the set, the greater the probability that the words contained in the merchandise title are messy.

For example, after the merchandise title “Paypal-Fashion sunglasses, ED sunglasses, CA sunglasses, Brand name sunglasses, designer sunglasses” undergoes stemming and comma-based division, the resulting segment set is {“Paypal-Fashion sunglass”, “ED sunglass”, “CA sunglass”, “Brand nam sunglass”, “design sunglass”}. The set of lengths corresponding to the segments is {2, 2, 2, 3, 2}, and the variance of segment length is 0.2.

Second, the syntactical characteristic attributes of the merchandise title are obtained from the merchandise information. This process first entails part-of-speech tagging of the merchandise title, i.e. tagging each word contained in the merchandise title with its corresponding part of speech, such as noun, verb, adjective or adverb. There is a relatively small number of part-of-speech categories (e.g., Penn TreeBank defines 36 parts of speech). Therefore, since features based on part-of-speech characteristics are more amenable to generalization than features based on lexical characteristics, one can interpret the applicable scope of this technical scheme broadly. In some embodiments, to increase the level of generalization even further, part-of-speech super-categories are defined. In some embodiments, part-of-speech super-categories define parts of speech as the following categories: noun (N), verb (V), adjective (JJ), adverb (ADV), preposition (TO), and numeral (DT). In conjunction with the description of syntactical characteristic attributes above, examples of values corresponding to syntactical characteristic attributes can include, but is not limited to, one or more of the following:

1. The ratio of the number parts of speech in the words contained in the merchandise title after the removal of repetitive parts of speech to the total number of parts of speech in the words of the merchandise title.

Generally, the lower the ratio of the number parts of speech in the words contained in the merchandise title after removal of repetitive parts of speech to the total number of parts of speech in the words of the merchandise title, the greater the probability that the words contained in the merchandise title are messy.

For example, assuming the merchandise title is “100% Original Asus P6T7 WS SuperComputer Motherboard, ASUS Motherboard, Computer Motherboard, Computer Mainboard, Motherboard,” the corresponding parts of speech will be “DT JJ N DT N N N, N N, N N, N N, N.” After the repetitive parts of speech are removed, the part-of-speech set is {“DT”, “JJ”, “N”}. Thus, the ratio of parts of speech after removal of the repetitive parts of speech to the total parts of speech for words in the merchandise title is 3/14.

2. The ratio of the number of words that are nouns in the merchandise title after the removal of repetitive words to the total number of words that are nouns.

In the field of e-commerce, nouns in the merchandise title tend to be richer in information because they describe more important merchandise information. In general, the merchandise name (e.g., product name) will be a noun. Therefore, generally, the lower the ratio of nouns that follow the removal of repetitive words from the merchandise title to the total number of nouns, the greater the probability that the words contained in the merchandise title are messy.

For example, in the merchandise title “100% Original Asus P6T7 WS SuperComputer Motherboard, ASUS Motherboard, Computer Motherboard, Computer Mainboard, Motherboard”, the nouns are “Asus WS SuperComputer Motherboard ASUS Motherboard Computer Motherboard Computer Mainboard Motherboard,” and the noun set after removal of repetitive words is {“Asus”, “WS”, “SuperComputer”, “Motherboard, “Mainboard”}. Thus, the ratio of the nouns after the removal of repetitive words to total nouns in the merchandise title is 5/11.

3. Number of occurrences of the part of speech that occurs most frequently.

To improve identification of unpunctuated messy merchandise titles, in some embodiments, the frequency at which a part of speech occurs consecutively (i.e., as a bigram) is considered. Generally, the higher the frequency of consecutive parts of speech, the greater the probability that the words contained in the merchandise title are messy.

For example, for the merchandise title is “Power Amplifier Audio Amplifier Professional Power Amplifier Karaoke Amplifier Pa Pro Amplifier,” the corresponding part-of-speech string is “JJ N JJ N JJ N N N N N N N,” and the bigram part-of-speech set extracted therefrom is {“JJ N”, “N JJ”, “JJ N”, “N JJ”, “JJ N”, “N N”, “N N”, “N N”, “N N”, “N N”, “N N”}, wherein the bigram sequence that occurs most frequently (7 times) is “N N”.

4. The ratio of the number of parts of speech after the removal of repetitive words to the total number of parts of speech in a set, where the set comprises the parts of speech corresponding to words in a designated position(s) in each segment after the merchandise information has been divided into segments (e.g., subsets of words/phrases of the merchandise information) based on preset rules.

In some embodiments, the division of the merchandise information based on preset rules into segments includes, but is not limited to, dividing the merchandise information (e.g., merchandise title) based on the positions of commas in the merchandise title into segments and/or dividing the merchandise title based on the positions of the most frequently occurring words in the merchandise title.

Generally, after the merchandise title is divided into segments, the parts of speech corresponding to the last two words (bigrams) in each segment are designated members of a set. In this set, the lower the ratio of bigram parts of speech following the removal of repetitive parts of speech to total bigram parts of speech in the set, the greater the probability that the words contained in the merchandise title are messy.

For example, assuming that the merchandise title is “100% Original Asus P6T7 WS SuperComputer Motherboard, ASUS Motherboard, Computer Motherboard, Computer Mainboard, Motherboard,” the set composed of the parts of speech for the final two words in each segment is {“N N”, “N N”, “N N”, “N”}. (The final segment contains just one word; thus its bigram part-of-speech sequence is “N”). After removal of the repetitive words, the set is {“N N”, “N”}. Thus, the ratio between bigram parts of speech after the removal of repetitive parts of speech to the total number of bigram parts of speech in the set is 2/4.

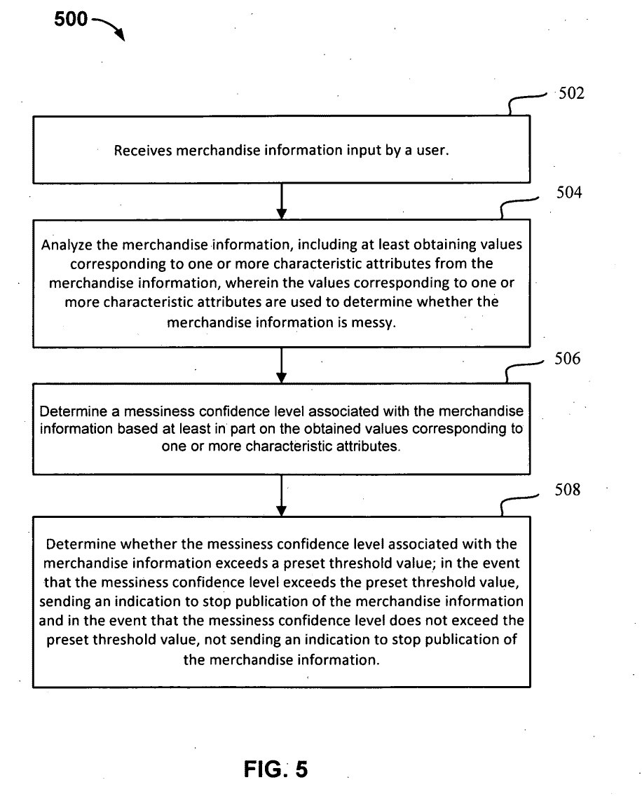

FIG. 5 is a flow diagram showing an embodiment of a process for analyzing merchandise information. In some embodiments, process 500 can be implemented at least in part by using system 200.

At 502: Merchandise information input by a user is received.

In some embodiments, merchandise information is entered by users (e.g., individuals with an account) at an electronic commerce website. In some embodiments, one or more users can sell products at the electronic commerce website by advertising the products at webpages of the electronic commerce website. For example, each user can have one or more webpages at the electronic commerce website at which they advertise one or more products that they offer. The users can also input and submit merchandise information related to those products and such information can be published at the appropriate websites. For example, a user can submit a piece of merchandise information for one or more than one of the products that the user is selling at a user interface webpage of the electronic commerce website.

At 504: The merchandise information is analyzed, including at least obtaining values corresponding to one or more characteristic attributes from the merchandise information, wherein the obtained values corresponding to one or more characteristic attributes are used to determine whether the merchandise information is messy.

In some embodiments, characteristic attributes include morphological characteristic attributes and/or syntactical characteristic attributes.

In some embodiments, examples of morphological characteristic attributes comprises any one or more of the following: number of commas contained in the merchandise information; sentence length of the merchandise information; ratio of number of words contained in the merchandise information after the removal of repetitive words to total number of words in the merchandise information; number of occurrences of the word that occurs most frequently in the merchandise information; ratio of number of words after the removal of repetitive words to total number of words in a set, where the set is composed of words at designated positions in each segment after the merchandise information has been divided into segments based on preset rules; the variance of each segment after the merchandise information has been divided into segments based on preset rules.

In some embodiments, examples of syntactical characteristic attribute comprises any one or more of the following: the ratio of the number of parts of speech corresponding to words contained in the merchandise information after the removal of repetitive parts of speech to the total number of parts speech corresponding to words in the merchandise information; the ratio of the number of words that are nouns in the merchandise information after the removal of repetitive parts of speech to the total number of words that are nouns; the number of occurrences of the part of speech that occurs most frequently; the ratio of the number of parts of speech after the removal of repetitive parts of speech to the total number of parts of speech in a set, where the set is composed of the parts of speech corresponding to the words in designated positions in each segment after the merchandise information has been divided into segments based on preset rules.

At 506: A messiness confidence level associated with the merchandise information is determined based at least in part on a maximum entropy principle for the obtained values corresponding to one or more characteristic attributes.

In some embodiments, determining the messiness confidence level associated with the merchandise information based at least in part on a maximum entropy principle for the obtained one or more characteristic attributes includes taking the obtained values of the characteristic attributes as the input information for a maximum entropy principle-based conditional probability model

$$p ( y \vert x ) = \frac{1}{Z ( x )} exp ( {\sum }_{j} {λ}_{j} {f}_{j} ( x , y ) ) ,$$

then using the conditional probability model to calculate, for the given input information, the posterior probability p(y|x) that said merchandise title is messy information. The posterior probability p(y|x) is deemed as the confidence level associated with the merchandise information.

At 508: It is determined whether the confidence level associated with the merchandise information exceeds a preset threshold value; in the event it is determined that the confidence level exceeds the preset threshold value, an indication to stop publication of the merchandise information is sent and in the event it is determined that the confidence level does not exceed the preset threshold value, an indication to stop publication of the merchandise information is not sent.

In some embodiments, the threshold confidence level is preset by an operator of system 200. In some embodiments, when the confidence level exceeds the threshold, the merchandise information is deemed to be messy and when the confidence level does not exceed the threshold, the merchandise information is deemed to be not messy. After the confidence level is determined to exceed the preset threshold value, publication (e.g., at an associated webpage) of the merchandise information is stopped and in some embodiments, analysis is performed to determine the keyword that causes the messiness of the merchandise information. In some embodiments, a keyword is deemed to be the main reason for the messiness of the merchandise information if it is the most frequently occurring word in the merchandise information. In some embodiments, the keyword that is deemed to be the main reason for the messiness of the merchandise information is returned (e.g., via a display at a user interface webpage) to the user. The user is subsequently prompted to make revisions to the merchandise information with respect to this keyword. For example, the user can submit a new merchandise information, such as one that contains fewer words and/or one that includes fewer repetitions of the keyword. In some embodiments, the user can be presented with automatic revisions of the merchandise information and the user can select one for submission for publication or refer to them in creating a new merchandise information to submit for publication.

Process 500 can be further described using the following examples of experimental data:

In some embodiments, the value of each characteristic attribute is normalized to a value between 0 and 1, which is then mapped onto an integer so as to simplify the subsequent computation process. For example, a value of 6 is normalized to 0.3 (i.e., 6/20, 20 being the normalizing parameter, which can based on the values of the normalized data) and is mapped onto the integer 3. In one example, the mapping relationship between the normalized value and the integer is as follows: 0->0, (0, 0.05]->1, (0.05, 0.15]->2, (0.15, 0.3]->3, (0.3, 0.5]->4, (0.5, 1]->5.

So, for example, if a merchandise title is “#24 Baseball Jersey,Baseball Jerseys,Jerseys,Sports Jerseys,Sport Jersey, Jersey,24# Baseball Jersey,” the characteristic attributes obtained on the basis of merchandise title analysis results are the following values, which are to be used with Formula 1, as mentioned above:

The number of commas contained in the merchandise title is 6, which is converted through normalization to 0.3, which is then converted through mapping to 3. It corresponds to λ₁f₁(x, y), wherein, the hypothesis value of λ₁ is 0.0653117, and the value of f₁(x, y) is

$${f}_{1} ( x , y ) = \{ \begin{matrix}1 & \begin{matrix}if x = comma characteristic ID is 3 \\ and so y = title is messy\end{matrix} \\ 0 & else\end{matrix}$$

The merchandise title sentence length is 20, which is converted through normalization to 0.20 and then is converted through mapping to the integer 2. It corresponds to λ₂f₂(x, y). The hypothesis value of λ₂ is 0.853789, and the value of f₂(x, y) is

$${f}_{2} ( x , y ) = \{ \begin{matrix}1 & \begin{matrix}if x = sentence length characteristic ID is 2 \\ and so y = title is messy\end{matrix} \\ 0 & else\end{matrix}$$

The ratio of the number of words contained in the merchandise title after the removal of repetitive words to the total number of words in the merchandise title is 4/14, which is converted through normalization to 0.28 and then is converted through mapping to the integer 3. It corresponds to λ₃f₃(x, y). The value of λ₃ is −0.177941, and the value of f₃(x, y) is assumed to be

$${f}_{3} ( x , y ) = \{ \begin{matrix}1 & \begin{matrix}if x = word repetition characteristic ID is 5 \\ and so y = title is messy\end{matrix} \\ 0 & else\end{matrix}$$

The number of occurrences of the most frequently occurring word in the merchandise title is 7, which is converted through normalization to 0.35 and then is converted through mapping to 3. It corresponds to λ₄f₄(x, y). The hypothesis value of λ₄ is 0.457743, and the value of f₄(x, y) is

$${f}_{4} ( x , y ) = \{ \begin{matrix}1 & \begin{matrix}if x = number of most frequent word ID is 3 \\ and so y = title is messy\end{matrix} \\ 0 & else\end{matrix}$$

The ratio of the number of words following the removal of repetitive words to the total number of words in a set, which is composed of the words in a specified position within each segment (after the merchandise title has been divided based on preset rules into segments). The above is split into three situations:

The ratio of the number of words following the removal of repetitive words to the total number of words in a set, which is composed of the last words within each segment, after the merchandise title has been divided according to the positions of the commas contained in the title into a certain number of segments is 1/7, which is converted through normalization to 0.14 and then converted through mapping to the integer 2. It corresponds to λ₅f₅(x, y). The hypothesis value of λ₅ is 1.7743, and the value of f₅(x, y) is

$${f}_{5} ( x , y ) = \{ \begin{matrix}1 & \begin{matrix}if x = characteristic ID is 2 \\ and so y = title is messy\end{matrix} \\ 0 & else\end{matrix}$$

The ratio of the number of words following the removal of repetitive words to the total number of words in a set which is composed of the last two words of each segment (after the merchandise title has been divided based on the positions of the commas contained in the title into segments) is 3/7, which is converted through normalization to 0.42 and then converted through mapping to the integer 4. It corresponds to λ₆f₆(x, y).

The hypothesis value of λ₆ is −0.24332, and the value of f₆(x, y) is

$${f}_{6} ( x , y ) = \{ \begin{matrix}1 & \begin{matrix}if x = characteristic ID is 3 \\ and so y = title is messy\end{matrix} \\ 0 & else\end{matrix}$$

The ratio of the number of words following the removal of repetitive words to the total number of words in a set which is composed of the last word of each segment (after the merchandise title has been divided based on the most frequently occurring word contained in the title into segments) is 2/7, which is converted through normalization to 0.29 and then converted through mapping to the integer 3. It corresponds to λ₇f₇(x, y). The hypothesis value of λ₇ is 0.410227, and the value of f₇(x, y) is

$${f}_{7} ( x , y ) = \{ \begin{matrix}1 & \begin{matrix}if x = characteristic ID is 4 \\ and y = title is messy\end{matrix} \\ 0 & else\end{matrix}$$

After the merchandise title is divided based on preset rules into segments, the variance of each segment is 0.28, which maps to 2. It corresponds to λ₈f₈(x, y). The hypothesis value of λ₈ is −0.188554, and the value of f₈(x, y) is

$${f}_{8} ( x , y ) = \{ \begin{matrix}1 & \begin{matrix}if x = characteristic ID is 2 \\ and so y = title is messy\end{matrix} \\ 0 & else\end{matrix}$$

The ratio of the number of parts of speech corresponding to words contained in the merchandise title after removal of repetitive parts of speech to the total number of parts of speech corresponding to words in the merchandise title is 2/14, which is converted through normalization to 0.14 and is then converted through mapping to the integer 2. It corresponds to λ₉f₉(x, y). The hypothesis value of λ₉ is −0.0397724, and the value of f₉(x, y) is

$${f}_{9} ( x , y ) = \{ \begin{matrix}1 & \begin{matrix}if x = characteristic ID is 2 \\ and so y = title is messy\end{matrix} \\ 0 & else\end{matrix}$$

The ratio of the number of words in the merchandise title that are nouns after removal of repetitive parts of speech to the total number of words that are nouns is 3/15, which is converted through normalization to 0.2 and then converted through mapping to the integer 2. It corresponds to λ₉f₉(x, y). The hypothesis value of λ₁₀ is 0.305969, and the value of f₁₀(x, y) is

$${f}_{10} ( x , y ) = \{ \begin{matrix}1 & \begin{matrix}if x = characteristic ID is 4 \\ and so y = title is messy\end{matrix} \\ 0 & else\end{matrix}$$

The number of occurrences of the most frequently occurring part of speech is 12, which is converted through normalization to 0.6 and then converted through mapping to the integer 6. It corresponds to λ₁₁f₁₁(x, y). The hypothesis value of λ₁₁ is 0.105729, and the value of f₁₁(x, y) is f₁₁(x, y)={1 if x=characteristic ID is 24 and so y=title is messy 0 else

The ratio of the number of parts of speech following the removal of repetitive parts of speech to the total number of parts of speech in the set which is composed of the parts of speech in designated positions in each segment (after the merchandise information has been divided into segments) is 2/7, which is converted through normalization to 0.28 and then converted through mapping to the integer 3. It corresponds to λ₁₂f₁₂(x, y). The hypothesis value of λ₁₂ is −0.174333, and the value of f₁₂(x, y) is

$${f}_{12} ( x , y ) = \{ \begin{matrix}1 & \begin{matrix}if x = characteristic ID is 4 \\ and so y = title is messy\end{matrix} \\ 0 & else\end{matrix} .$$

Based on the described-above characteristic attributes as the given input information for Formula 1, the posterior probability p(x|y) is 0.989271, and the hypothesis threshold value is 0.7. The posterior probability, which serves as the confidence level, is above the threshold value. Therefore, it is determined that words contained in the merchandise title input by the user are messy and that their publication should be stopped. The above description of using characteristic attributes is merely an example, and any subset of the characteristic attributes can be used to calculate the confidence level (e.g., posterior probability) for a piece of merchandise information.

A person skilled in the art can modify and vary the disclosed embodiments without departing from the spirit and scope of the present application. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of analyzing merchandise information, comprising:
receiving merchandise information input by a user;
analyzing the merchandise information, including at least obtaining values corresponding to one or more characteristic attributes from the merchandise information, wherein the values corresponding to one or more characteristic attributes are used to determine whether the merchandise information is messy;
determining a messiness confidence level associated with the merchandise information based at least in part on the obtained values corresponding to one or more characteristic attributes; and
determining whether the messiness confidence level associated with the merchandise information exceeds a preset threshold value; in the event that the messiness confidence level exceeds the preset threshold value, sending an indication to stop publication of the merchandise information and in the event that the messiness confidence level does not exceed the preset threshold value, not sending an indication to stop publication of the merchandise information.

2. The method of claim 1, wherein the merchandise information is received in association with an electronic commerce website.

3. The method of claim 1, wherein the merchandise information includes one or more of the following: merchandise title, merchandise descriptive information, merchandise introductory information, merchandise reviews, and merchandise product specifications.

4. The method of claim 1, wherein determining a messiness confidence level associated with the merchandise information based at least in part on the obtained values corresponding to one or more characteristic attributes includes:
inputting the obtained values corresponding to one or more characteristic attributes into a conditional probability model; and
calculating a posterior probability associated with a likelihood that the merchandise information is messy using at least the obtained values corresponding to one or more characteristic attributes and the conditional probability model, wherein the messiness confidence level comprises the posterior probability.

5. The method of claim 1, wherein the one or more characteristics attributes includes at least one morphological characteristic attribute.

6. The method of claim 5, wherein the at least one morphological characteristic attribute includes one or more of the following:
number of commas contained in the merchandise information; sentence length of the merchandise information; ratio of number of words contained in the merchandise information after removal of repetitive words to total number of words in the merchandise information; number of occurrences of a word that occurs most frequently in the merchandise information; ratio of number of words after removal of repetitive words to total number of words in a set, wherein the set is composed of words at designated positions in each segment after the merchandise information has been divided into segments based on preset rules; a variance of each segment after the merchandise information has been divided into segments based on preset rules.

7. The method of claim 1, wherein the one or more characteristics attributes includes at least one syntactical characteristic attribute.

8. The method of claim 7, wherein the at least one syntactical characteristic attribute includes one or more of the following:
a ratio of a number of parts of speech corresponding to words contained in the merchandise information after removal of repetitive parts of speech to a total number of parts of speech corresponding to words in the merchandise information; a ratio of a number of words that are nouns in the merchandise information after removal of repetitive words to a total number of words that are nouns;
a number of occurrences of a part of speech that occurs most frequently; a ratio of the number of parts of speech after removal of repetitive parts of speech to the total number of parts of speech in a set, where the set is composed of the parts of speech corresponding to words in designated positions in each segment after the merchandise information has been divided into segments based on preset rules.

9. The method of claim 6, further comprising dividing the merchandise information into segments based on preset rules including:
dividing the merchandise information based on positions of commas in the merchandise information to form one or more segments, wherein a segment comprises a subset of the words included in the merchandise information;
and/or
dividing the merchandise information based on positions of a word that occurs most frequently in the merchandise information to form one or more segments.

10. The method of claim 8, further comprising dividing the merchandise information into segments based on preset rules including:
dividing the merchandise information based on positions of commas in the merchandise to information to form one or more segments, wherein a segment comprises a subset of the words included in the merchandise information;
and/or
dividing the merchandise information based on positions of a word that occurs most frequently in the merchandise information to form one or more segments.

11. The method of claim 1, in the event that the messiness confidence level does exceed the preset threshold value, determining that the merchandise information comprises a messy merchandise information.

12. The method of claim 11, in the event that the messiness confidence level does exceed the preset threshold value, further comprising:
determining a keyword of the merchandise information likely causing messiness associated with the merchandise information; and
presenting an indication regarding the keyword via an interface element accessible by the user.

13. The method of claim 12, further comprising, prompting the user to input a revision to the merchandise information via the interface element.

14. A system for analyzing merchandise information, comprising:
a processor configured to:
receive merchandise information input by a user,
analyze the merchandise information, including at least obtaining values corresponding to one or more characteristic attributes from the merchandise information, wherein the values corresponding to one or more characteristic attributes are used to determine whether the merchandise information is messy,
determine a messiness confidence level associated with the merchandise information based at least in part on the obtained values corresponding to one or more characteristic attributes, and
determine whether the messiness confidence level associated with the merchandise information exceeds a preset threshold value; in the event that the messiness confidence level exceeds the preset threshold value, sending an indication to stop publication of the merchandise information and in the event that the messiness confidence level does not exceed the preset threshold value, not sending an indication to stop publication of the merchandise information; and
a memory coupled to the processor and configured to provide the processor with instructions.

15. The system of claim 14, wherein the merchandise information is received in association with an electronic commerce website.

16. The system of claim 14, wherein the merchandise information includes one or more of the following: merchandise title, merchandise descriptive information, merchandise introductory information, merchandise reviews, and merchandise product specifications

17. The system of claim 14, wherein the processor configured to determine a messiness confidence level associated with the merchandise information based at least in part on the obtained values corresponding to one or more characteristic attributes includes the processor configured to:
input the obtained values corresponding to one or more characteristic attributes into a conditional probability model; and
calculate a posterior probability associated with a likelihood that the merchandise information is messy using at least the obtained values corresponding to one or more characteristic attributes and the conditional probability model, wherein the messiness confidence level comprises the posterior probability.

18. The system of claim 14, wherein the one or more characteristics attributes includes at least one morphological characteristic attribute.

19. The system of claim 14, wherein the one or more characteristics attributes includes at least one syntactical characteristic attribute.

20. The system of claim 14, in the event that the messiness confidence level does exceed the preset threshold value, the processor is configured to determine that the merchandise information comprises a messy merchandise information.

21. The system of claim 20, in the event that the messiness confidence level does exceed the preset threshold value, the processor is further configured to:
determine a keyword of the merchandise information likely causing messiness associated with the merchandise information; and
present an indication regarding the keyword via an interface element accessible by the user.

22. The system of claim 21, the processor is further configured to prompt the user to input a revision to the merchandise information via the interface element.

23. A computer program product for analyzing merchandise information, the computer program product being embodied in a computer readable storage medium and comprising computer instructions for:
receiving merchandise information input by a user;
analyzing the merchandise information, including at least obtaining values corresponding to one or more characteristic attributes from the merchandise information, wherein the values corresponding to one or more characteristic attributes are used to determine whether the merchandise information is messy;
determining a messiness confidence level associated with the merchandise information based at least in part on the obtained values corresponding to one or more characteristic attributes; and
determining whether the messiness confidence level associated with the merchandise information exceeds a preset threshold value; in the event that the messiness confidence level exceeds the preset threshold value, sending an indication to stop publication of the merchandise information and in the event that the messiness confidence level does not exceed the preset threshold value, not sending an indication to stop publication of the merchandise information.
